(19) United States
(12) Patent Application Publication
(10) Pub. No.: US 2013/0151316 A1
(43) Pub. Date: Jun. 13, 2013

(54) Methodology for Restoring the Sustainable Profitability of a Business Unit through Operational and Process Re-Engineering (Operational Turnaround)

(71) Applicants: Ileana Roman Stoica, La Grange, KY (US); Sorn Roman Stoica, La Grange, KY (US)

(72) Inventors: Ileana Roman Stoica, La Grange, KY (US); Sorn Roman Stoica, La Grange, KY (US)

(21) Appl. No.: 13/316,516

(22) Filed: Dec. 11, 2011

(51) Int. Cl. G06Q 10/06

(52) U.S. Cl. 705/7.36

(57) ABSTRACT

A methodology for restoring the sustainable profitability of a business unit through operational and process re-engineering (operational turnaround), which includes the following stages: an initial assessment (i.e. financial sustainability in the absence of any operational turnaround action or infusion of funds, evaluation and prioritization of urgent needs, etc.), planning and pre-work (i.e. key performance indicators and goal setting, resource and documentation planning, transitional maps, etc.), execution (i.e. the actual operational and process re-engineering, deployment of customer-centric strategies, restructuring, downsizing, performance management, etc.), and stabilization (i.e. implementing control measures to prevent future losses, growth strategy design and implementation, measurements of performance sustainability, periodic data reviews, etc.).

### BACKGROUND OF THE INVENTION

Operational turnaround is the set of actions and strategies applied to reverse a company's descending trajectory: from descending or even free fall, back up towards profitability and stabilized growth.

There are three main reasons that would cause a business unit to be losing money:
(Sales) revenue is too low
Operating expenses are too high
Any combination of the above

While sales revenue cannot be increased beyond a certain level or, in times of recession, sales volume can remain volatile and constantly underperforming, an operational turnaround is the strategy that saves the company and positions it for future growth. This methodology does not focus on bankruptcy options, debt restructuring alternatives, or alternate sourcing strategies, but can enroll the assistance of such means.

The difference between a successful operational turnaround and an unsuccessful one is the ability to carefully balance the priorities, between the financial constraints of the troubled company, and its customers' best interest. This is a very thin line to walk, as for the successful execution of an operational turnaround there is very limited time and very little, if any, room for error. The long-term success of any turnaround depends on its stability. This, in turn, depends on the customer, and on the customer's willingness to remain loyal, refer, or further engage with the company. Therefore, part of ensuring the stabilization of any operation is a deep understanding of the customer's needs, wants, satisfiers and dissatisfiers, and the impact we make on every interaction with the customer.

The proposed methodology, operational turnaround, is built from the premise that the market, a.k.a. the customer, can bring invaluable input into creating the ideal footprint for any profitable business unit, and that long term success for any turnaround should come from customer-centric business process re-engineering rather than through financial speculation or maneuvering.

### SUMMARY OF THE INVENTION

This methodology allows the complex challenges of a business unit turnaround to be executed in a customer-centric, operationally sound manner that can lead to long term sustainable results. Because it is largely based on operational restructuring, process (re)-engineering, and data-based decision-making, we have dubbed it Operational Turnaround. To best illustrate this methodology, we will use several examples and illustrations.

This methodology for restoring the sustainable profitability of a business unit through operational and process re-engineering (operational turnaround), includes the following stages:
an initial assessment (i.e. financial sustainability in the absence of any operational turnaround action or infusion of funds, evaluation and prioritization of urgent needs, etc.);
planning and pre-work (i.e. key performance indicators and goal setting, resource and documentation planning, transitional maps, etc.);
execution (i.e. the actual operational and process re-engineering, deployment of customer-centric strategies, restructuring, downsizing, performance management, etc.);
stabilization (i.e. implementing control measures to prevent future losses, growth strategy design and implementation, measurements of performance sustainability, periodic data reviews, etc.).

The initial assessment stage of an operational turnaround includes a thorough analysis of the root causes of the decline. It includes an examination of all aspects of the business, such as process efficiencies, customer loyalty, company culture, sales performance, etc. Also in the assessment stage a timeline is created, based on the analysis of the financial sustainability of the business and cash flow resources. This timeline provides the operational turnaround leader with a timeframe for execution. In FIG. 01, we have the illustration of a deterrent analysis for an online sales company. This type of analysis is a very good illustration of customer-centric operational turnaround assessment analysis, because it provides insight into the sales deterrents and uses the voice of the customer to drive operational change. After executing the operational actions dictated by the deterrent analysis, our example company shows a modified deterrent analysis (not normalized) in FIG. 02. In FIG. 03, we illustrate the normalized data around product price, to see the actual benefit, and FIG. 04 shows the actual benefit of the operational turnaround process change.

The planning and pre-work stage of an operational turnaround includes, among others, key performance indicators and goal setting, resource and documentation planning, transitional maps, company culture evaluation, communication strategy design. FIG. 05 shows an operational turnaround transitional map for a multi-location car dealership, showing a footprint and expense reduction of more than 50%. Such a transitional map guides the operational turnaround team through executing timely and successfully on the planned actions. In the transitional map the company name is EXPL- short for EXAMPLE).

The execution stage of an operational turnaround includes, among others, the actual operational and process re-engineering, the deployment of customer-centric strategies, the introduction of new key performance indicators and formalized performance management plans, restructuring, downsizing, changes in company geographical areas, markets, or business areas of focus. FIG. 06 shows the operational turnaround plan for 38 store locations of a dealership chain, reflecting performance-based decision-making, as well as strategic (dealerships number 5 and 33 on the plan are to be kept open and restructured for strategic/physical location reasons, despite their financial performance).

FIG. 07 shows an example of an operational turnaround performance management and compensation system. To ensure the success of challenging, complex operational turnaround actions, there is a need of a very accurate, very motivational performance management system that allows for monthly performance reviews in minimal time, for all employees, with a compensation component tied into company performance. FIG. 07 illustrates such an example.

The stabilization stage of an operational turnaround includes, among others, implementing control measures to prevent future losses, growth strategy design and implementation, measurements of performance sustainability, periodic data reviews, etc.

In FIG. 08 we see the operational turnaround transitional map with results, showing the outcome of the turnaround action in out multi-location car sales example company.

A key part of the stabilization stage of an operational turnaround is stability and performance sustainability assessment. These are the true measures of success for an operational turnaround, showing if the actions taken have been sufficient to be launching the business unit on a path of continued growth. If stability has not been achieved, the operational turnaround is not completed. FIG. 09 shows a stable growth rate for an example company's revenue. FIG. 10 looks at net profit for the same company, and shows the same stable profitability growth path.

FIG. 11 and FIG. 12 are showing examples of unstable post turnaround performance and growth. FIG. 11 shows some improvement, yet the revenue line crosses under the cost barrier line on occasions, and this translates in an operating loss. FIG. 12 is a different view of an unstable performance, showing the net profit (loss) line crossing into negative values on several occasions. For such outcomes, the operational turnaround is not deemed complete, but this is exactly the reason why stability and performance sustainability assessment is critical to the successful operational turnaround.

### BRIEF DESCRIPTION OF THE DRAWINGS

FIG. 1: Pre-Turnaround Deterrents to Purchasing

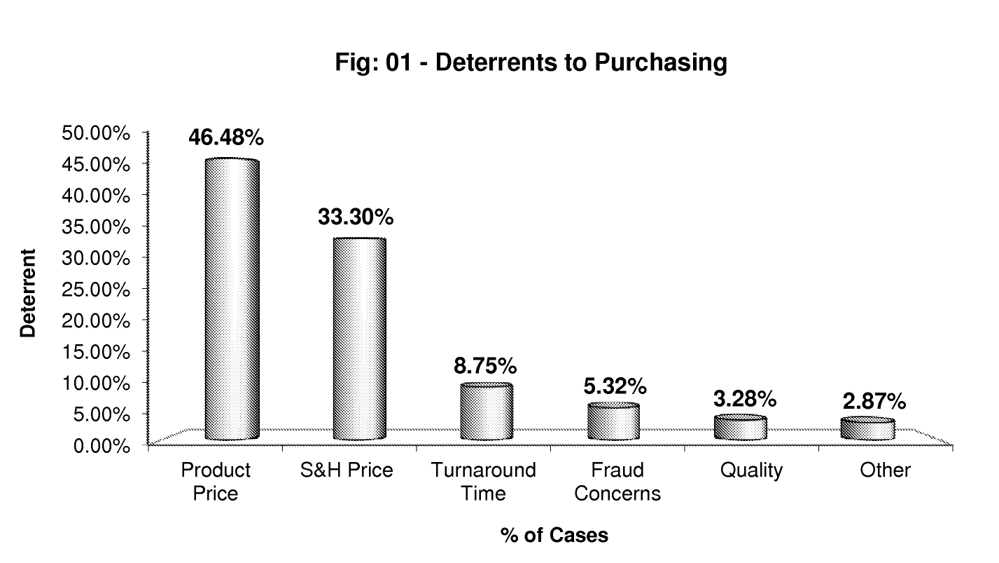

FIG. 2: Post Turnaround Deterrents to Purchasing

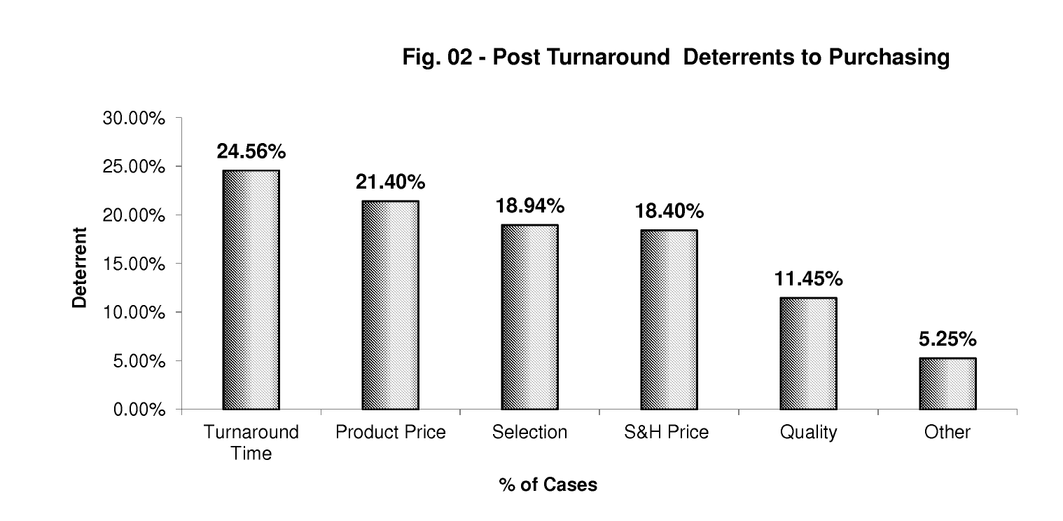

FIG. 3: Results—Pre and Post Operational Re-engineering of Online Sales Processes

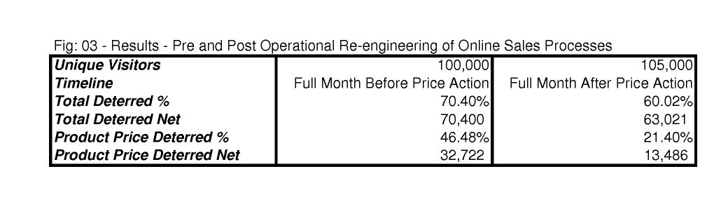

FIG. 4: Post Turnaround Product Price deterrent Improvement

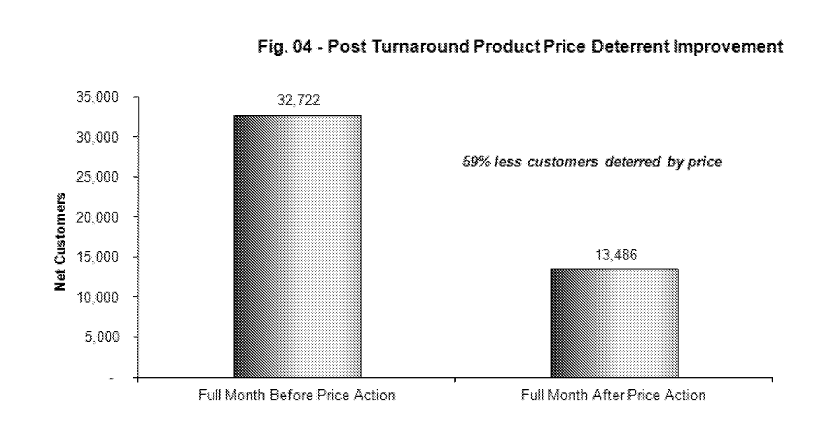

FIG. 5: Operational Turnaround Transitional Map

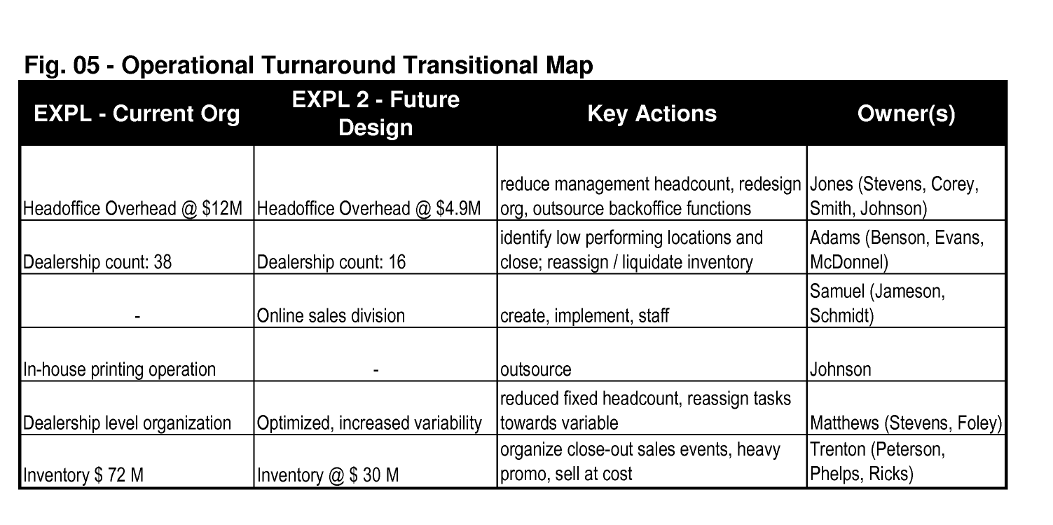

FIG. 6: Operational Turnaround Plan for Multiple Dealership Locations

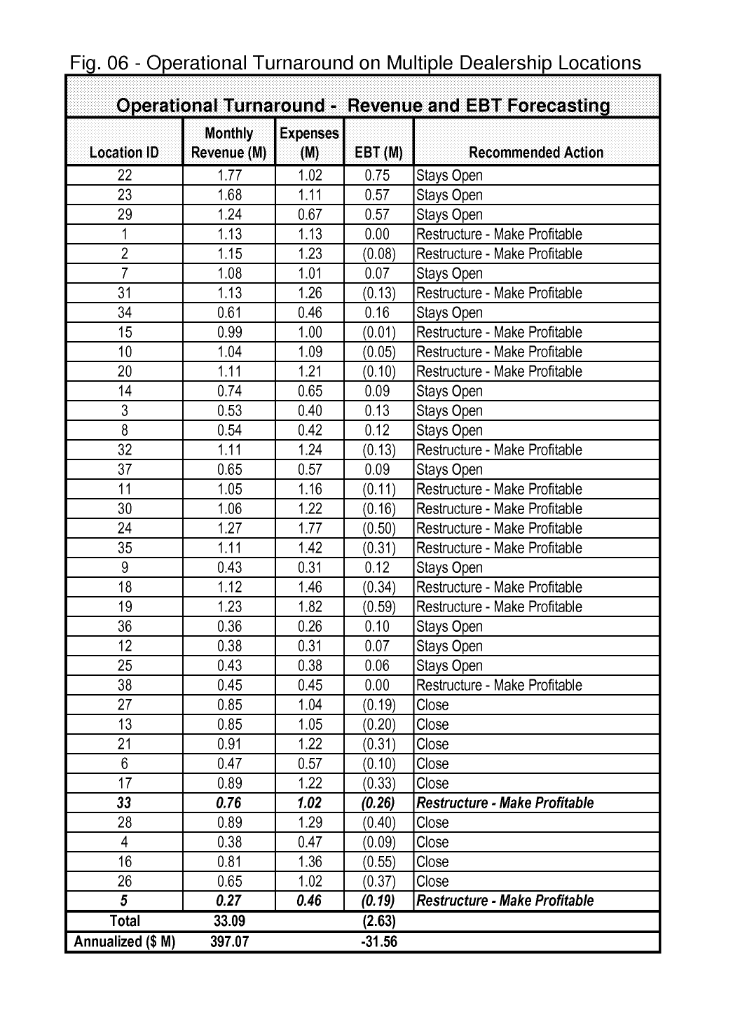

FIG. 7: Operational Turnaround Performance Management and Compensation System

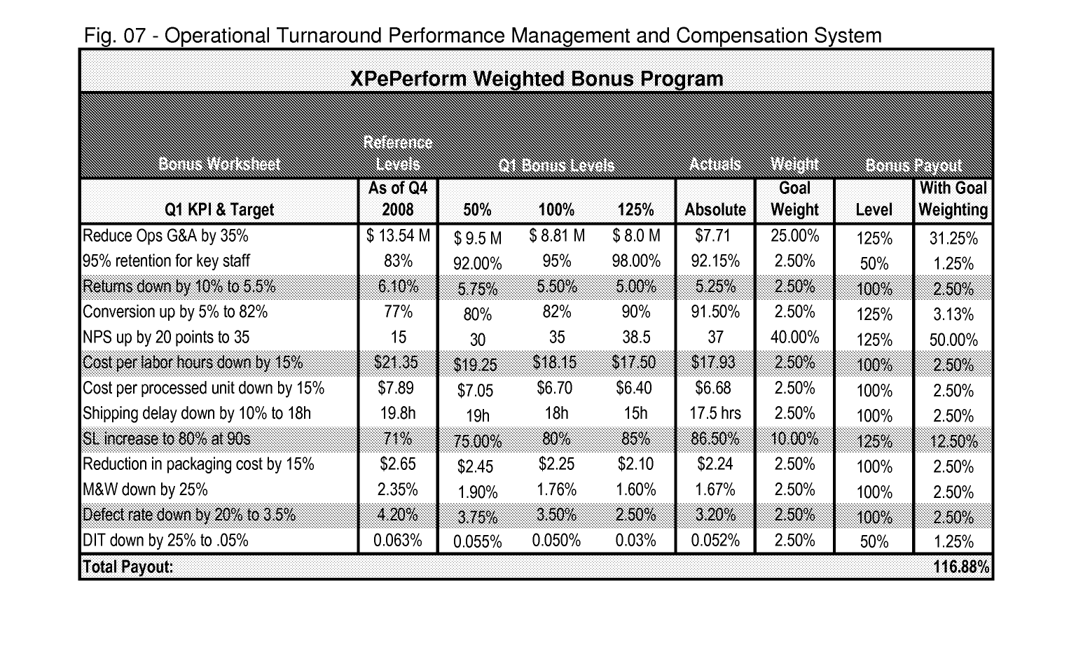

FIG. 8: Operational Turnaround Transitional Map with Results

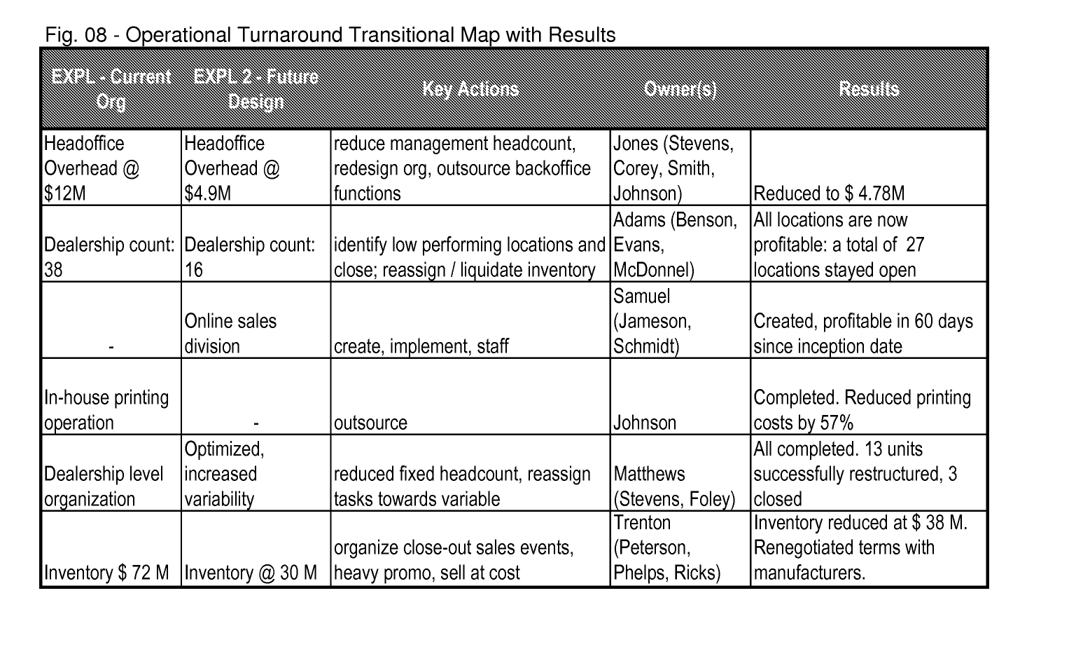

FIG. 9: Pre- and Post Turnaround Revenue Chart, Showing a Stable Growth Trend

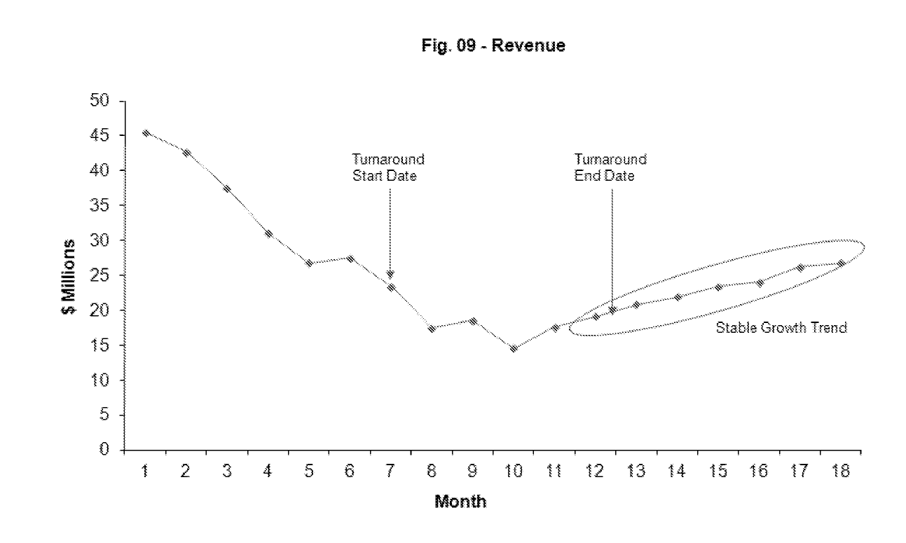

FIG. 10: Net Profit/Loss By Month Chart Showing a Stable Growth Trend

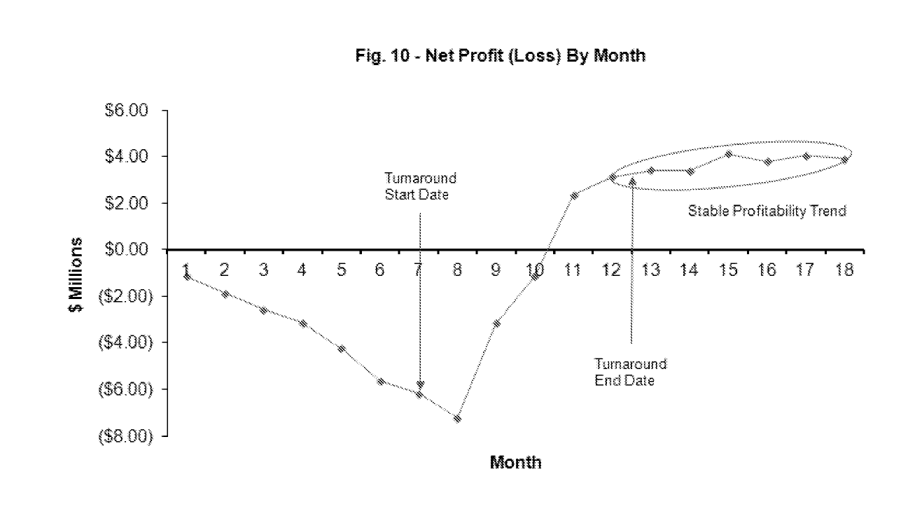

FIG. 11: Revenue vs. Cost Barrier Chart Showing an Unstable Growth Trend

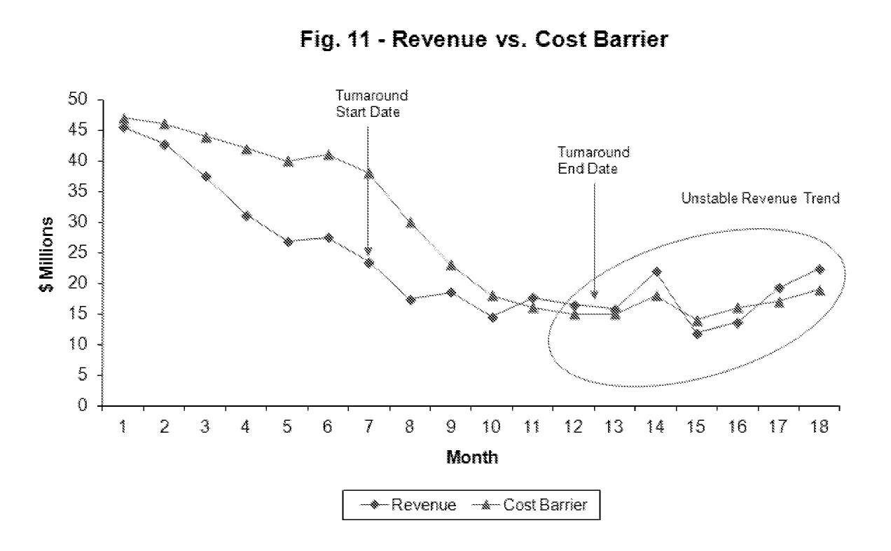

FIG. 12: Net Profit/Loss By Month Chart Showing an Unstable Growth Trend

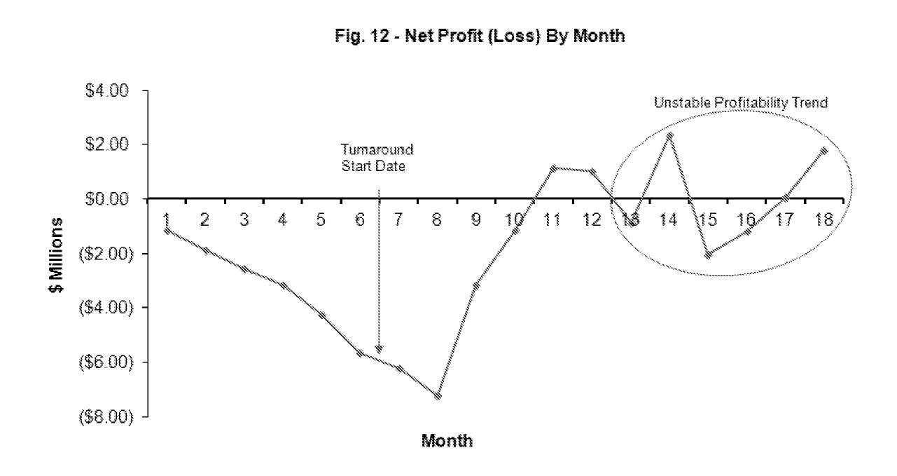

1. A methodology for restoring the sustainable profitability of a business unit through operational and process re-engineering (operational turnaround), which includes the following stages: (a) an initial assessment (i.e. financial sustainability in the absence of any operational turnaround action or infusion of funds, evaluation and prioritization of urgent needs, etc.), (b) planning and pre-work (i.e. key performance indicators and goal setting, resource and documentation planning, transitional maps, etc.), (c) execution (i.e. the actual operational and process re-engineering, deployment of customer-centric strategies, restructuring, downsizing, performance management, etc.), and (d) stabilization (i.e. implementing control measures to prevent future losses, growth strategy design and implementation, measurements of performance sustainability, periodic data reviews, etc.).

2. The methodology of claim 1, wherein the business unit could be production, services, membership-based, financial, government, or any type of business unit that is aiming to be profitable, or at the very least financially self-sustainable.

3. The methodology of claim 1, wherein the business unit could be an administrative unit (i.e. government organization, etc.)

4. The methodology of claim 1, wherein the operational turnaround is executed after other turnaround approaches have failed to yield the expected stable results.

5. The methodology of claim 1, wherein the operational turnaround is executed to avoid bankruptcy filing.

6. The methodology of claim 1, wherein the operational turnaround is executed under bankruptcy protection.

7. The methodology of claim 1, wherein the operational turnaround is executed to correct a dissatisfactory profitability trend, even if the business unit is still financially sustainable.

8. The methodology of claim 1, wherein the application is limited to parts or departments of a business unit.

9. The methodology of claim 1, wherein the assessment stage includes a root cause analysis of process failures.

10. The methodology of claim 1, wherein the assessment stage includes an evaluation of the company culture.

11. The methodology of claim 1, wherein the planning and pre-work stage includes an internal and external communication plan.

12. The methodology of claim 1, wherein the execution stage can include resource re-allocation.

13. The methodology of claim 1, wherein the execution stage can include business expansion into different geographical areas, markets, or lines of business.

14. The methodology of claim 1, wherein the execution stage can include business contraction from different geographical areas, markets, or lines of business.

15. The methodology of claim 1, wherein the execution stage can include human and capital resources downsizing.

16. The methodology of claim 1, wherein the stabilization stage can include performance thresholds that, if not met, can trigger further operational turnaround action.

17. A computerized or automated system using an application (software package, system, application, app, etc.) for the management of restoring the sustainable profitability of a business unit through operational and process re-engineering (operational turnaround), which includes the following stages: (a) an initial assessment (i.e. financial sustainability in the absence of any operational turnaround action or infusion of funds, evaluation and prioritization of urgent needs, etc.), (b) planning and pre-work (i.e. key performance indicators and goal setting, resource and documentation planning, transitional maps, etc.), (c) execution (i.e. the actual operational and process re-engineering, deployment of customer-centric strategies, restructuring, downsizing, performance management, etc.), and (d) stabilization (i.e. implementing control measures to prevent future losses, growth strategy design and implementation, measurements of performance sustainability, periodic data reviews, etc.).

18. The system of claim 17 further comprising one or more computers configured to prompt or enable one or more users to lead or contribute to an operational turnaround.

19. The system of claim 17 further comprising the functionality of management, tracking, documentation, change management, communication, and archiving of performance indicators for said business units.

20. The system of claim 17 further comprising the functionality of performance management (including compensation), based on performance indicators for said units.
